(19) United States
(12) Patent Application Publication
(10) Pub. No.: US 2007/0150142 A1
(43) Pub. Date: Jun. 28, 2007

(54) Vehicle information system

(75) Inventors: Stephan Cieler, Frankfurt (DE); Vera Donk, Babenhausen (DE); Jurgen Dreyer, Schaafheim-Mosbach (DE); Guido Meier-Arendt, Langen (DE); Heiko Schnieders, Schaafheim (DE); Thomas Sulzbach, Offenbach (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft

(21) Appl. No.: 11/601,925

(22) Filed: Nov. 20, 2006

(30) Foreign Application Priority Data
Nov. 24, 2005 (DE) 10 2005 056 047.4

(51) Int. Cl. G06F 19/00

(52) U.S. Cl. 701/35

(57) ABSTRACT

A vehicle information system having a mode of operation for vehicle navigation and a mode of operation for telecommunication is presented. The system includes a database and a control and regulation unit that includes a processor configured for storing and executing control commands. The system further includes a display device connected to the control and regulation unit, an input apparatus connected to the control and regulation unit, and a data store which can store data records, image files, and control commands which can be stipulated for the data records.

### BACKGROUND OF THE INVENTION

1. Field of the Invention

The invention relates generally to vehicle information systems, and more particularly to a vehicle information system having a mode of operation for vehicle navigation and/or a mode of operation for telecommunication.

2. Description of the Related Art

Vehicle information systems are used in motor vehicles for diverse purposes. On the one hand, various information, normally relating to vehicle operation, is displayed to the user using a central display device. The user can also make various settings and control functions of the vehicle individually. Thus, by way of example, the user is able to control a radio or other electronic entertainment appliance using the vehicle information system. Besides setting an air-conditioning installation and other apparatuses used both for user comfort and safety, vehicle information systems are also used to reproduce technical data. Normally, modern vehicle information systems also have a navigation system in which the driver is able to input a destination and is guided to the destination by the navigation system through determination of the current location by means of satellite-assisted position finding and subsequent route calculation using stored map material with continuous instructions. Another important field of use for vehicle information systems is the area of telecommunication, where the vehicle information system actuates a telecommunication apparatus, for example in the form of an integrated and/or separate mobile telephone. However, it has been found that particularly these two areas, i.e. both the input of destination addresses into navigation systems and the selection of destination telephone numbers from telephone number stores, require increased attention by the user and consequently distract the vehicle driver during the journey. The reason for this is that destinations or telephone numbers from an appropriate database are typically input or selected using alphanumeric entries. The associated visual and cognitive demand on the vehicle driver results in restricted capability in traffic and in a risk to traffic safety.

### SUMMARY OF THE INVENTION

An object of the present invention is therefore to provide a vehicle information system which ensures simple and rapid selection of destinations or telephone numbers from an appropriate database.

The object is met by a vehicle information system having a modes of operation for vehicle navigation and/or telecommunication in which the data records can be freely allocated a respective image file which can be selected from a plurality of image files, the created links can be stored in the data store and, for the purpose of selecting a data record, the associated image files can be graphically displayed using a display device, with a data record being able to be selected in image-assisted manner using the displayed image files by operating an input apparatus, and a control command linked to the data record being able to be initiated.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is an illustrative block diagram of a vehicle information system, according to one embodiment of the invention.

### DETAILED DESCRIPTION OF THE PRESENTLY PREFERRED EMBODIMENTS

The present invention concerns itself with a vehicle information system having a mode of operation for vehicle navigation and/or a mode of operation for telecommunication.

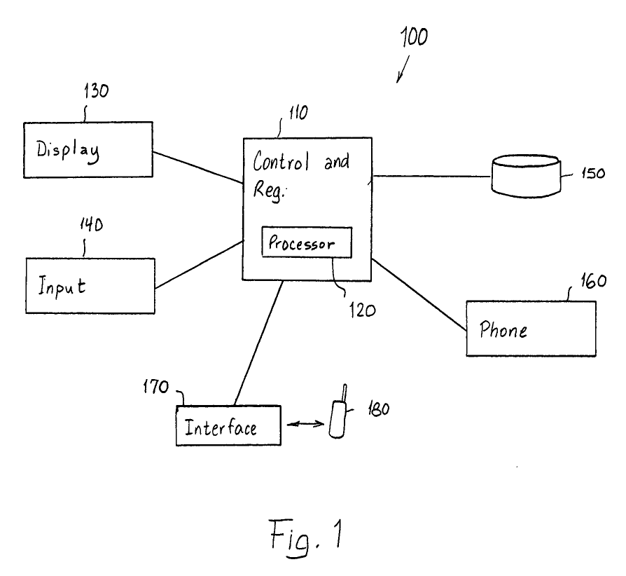

Referring to FIG. 1, in one embodiment, the vehicle information system 100 includes, for the purpose of finding and selecting a data record from a series of data records in a database, a control and regulation unit 110 with a processor 120 in which control commands can be stored and executed. The vehicle information system 100 further includes a display device 130 and an input apparatus 140 (e.g., keypad, touch screen), which are connected to the control and regulation unit 110. The vehicle information system 100 also includes a data store (i.e., a database) 150 which can store data records, image files, and control commands which can be stipulated for the data records. The invention also concerns itself with a method for the manner of operation of the vehicle information system 100 of this kind.

In one preferred embodiment, the vehicle information system 100 operates as a vehicle navigation system. In vehicle navigation mode, a menu item can be used to select the input of destination addresses for routing. The image files that are displayed on display device 130 are linked to a respective data record which contains destination data for the routing, where the destination for which a course is set can be selected in image-assisted manner using the displayed image files by operating the input apparatus 140 (e.g., selecting an icon via a graphical user interface as is known in the art), and a control command linked to the data record can be initiated in order to transfer the destination data for the navigation system's routing which is contained in the data record and in order to perform the routing. This allows the vehicle user to select a desired destination address and start the routing more quickly.

Another preference is an embodiment in which when the destination is reached the image file which is linked to the data record whose destination matches the destination reached appears on the display device. The driver is therefore provided with a quickly identifiable report, which can be checked at a glance, about successfully performed routing. However, it is also conceivable to use the image file to provide the driver with specific information which he would otherwise have to look up in his documents, for example by depicting an interlocutor to whom the driver is en route, which means that it is possible for the driver to identify this person more quickly, for example at the start of a meeting or in a restaurant.

In a further embodiment, the vehicle information system 100 includes a telephone 160 or an interface 170 to a mobile telephone 180. In a telecommunications mode of operation, a menu item can be used to select a connection setup to a telecommunication subscriber. The image files displayed on the display device 130 are linked to a respective data record (e.g., stored in the database 150) that contains at least one telephone number for a telecommunication subscriber and other data suitable for identifying telecommunication subscribers. The telecommunication subscriber to be called can be selected in image-assisted manner (e.g., selecting or clicking an icon on the display device 130) using the displayed image files by operating the input apparatus 140. A control command linked to the data record can be initiated in order to call the destination telephone number of the telecommunication subscriber and to set up the connection.

Because of the aforementioned faster perception of the image-based and/or icon-based information, the user is therefore able to select a telecommunication subscriber using displayed image files more quickly instead of looking for a desired entry in an alphanumeric list. The process of selecting and setting up the connection is therefore shortened to a minimum, which helps to increase safety.

In one expedient refinement of the invention, a call prompts the image file that is linked to the data record (e.g., stored in the database 150) of the calling communication subscriber to appear on the display device 130, where the communication subscriber is identified from the transmitted telephone number or from other caller data that is suitable for identification. In comparison with the usual display of a telephone number or of a name on the display device 130, the vehicle user can identify the calling communication subscriber more quickly as a result of the display of an image file. The vehicle user can also identify the calling communication subscriber more quickly because the display device 130 in a vehicle information system 100 is typically arranged at a point which is favorably placed for the vehicle driver so that the vehicle driver can always keep an eye on the area of road ahead and is not unnecessarily distracted from what is happening in the traffic.

In a more preferred embodiment, an interface on the control and regulation unit 110 is provided for wire-based and/or wireless data interchange with other communication apparatuses. This means that, by way of example, data from an external mobile telephone 180 or a PDA (personal digital assistant) can be interchanged with the vehicle information system 100. This makes it possible to perform synchronization or a backup, which ensures that the various communication appliances used by a user also have the same up-to-date data and that up-to-date data can be provided in the event of a data loss. In addition, the opportunity for data interchange can also be used to record images of communication subscribers or also images of journey destinations, for example, using a mobile telephone 180 with an integrated camera or an external digital camera and to make these available to the vehicle information system 100 as an image file.

In one expedient development, the image files are linked to audio files in order to provide the vehicle driver not only with graphical reproduction of the image files but also with the option of an audio signal.

The advantage of the inventive vehicle information system 100 is that an entry in a database, for example a telephone number or a desired destination, can be selected easily and quickly because information based on an image or an icon is perceived more quickly than alphanumeric information, where first of all letters and/or numbers have to be detected so as then to associate them with a particular concept. Image-assisted selection of database entries therefore requires less attention from the vehicle driver, which means that he is also less distracted from what is currently happening in the traffic and for a much shorter time. The individual association of a graphical depiction with a particular data record provides the user with the opportunity to bring the depictions which are intended to be displayed to him for the purpose of selecting a data record into line with his personal needs and ideas, which allows the step of detection and selection to be optimized.

Variations, modifications, and other implementations of what is described herein may occur to those of ordinary skill in the art without departing from the spirit and scope of the invention. Accordingly, the invention is not to be defined only by the preceding illustrative description.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A vehicle information system having a mode of operation for vehicle navigation and a mode of operation for telecommunication, the vehicle information system comprising:
a database;
a control and regulation unit comprising a processor configured for storing and executing control commands, the control and regulation unit configured for finding and selecting a data record from a series of data records in the database;
a display device connected to the control and regulation unit;
an input apparatus connected to the control and regulation unit; and
a data store which can store data records, image files, and control commands which can be stipulated for the data records;
said control and regulation unit being configured to link each of the data records to a respective image file which is selectable from a plurality of image files, store the created links in the data store and, graphically display the associated image files on the display device for the purpose of selecting a data record, wherein a data record is selectable in an image-assisted manner using the displayed image files by operating the input apparatus, said control and regulation unit being further configured to initiate a linked one of the control commands that is linked to the selected data record.

2. The vehicle information system of claim 1, wherein said control and regulation unit is configured, in the mode of operation for vehicle navigation, to display image files linked to ones of the data records comprising destination data for routing so that the destination for which a course is set is selectable in image-assisted manner using the displayed image files by operating the input apparatus, each of the data records comprising destination data being linked to a control command for transferring the destination data for the navigation system's routing for performing the routing.

3. The vehicle information system of claim 2, wherein the display device is configured to display the image file which is linked to the selected data record when the destination is reached.

4. The vehicle information system of claim 1, further comprising an integrated telephone or an interface to a mobile telephone.

5. The vehicle information of claim 4, wherein said control and regulation unit is configured, in the mode of operation for telecommunication, to display image files linked to respective data records which contain at least one telephone number for the telecommunication subscriber and other data suitable for identifying the telecommunication subscriber, such that the telecommunication subscriber to be called is selectable in an image-assisted manner using the displayed image files by operating the input apparatus, each of the data records which contain at least one telephone number for the telecommunication subscriber being linked to a control command for calling the destination telephone number of the telecommunication subscriber and setting up the connection.

6. The vehicle information system of claim 5, wherein the display device is configured to display an image file which is linked to a data record of the calling telecommunication subscriber to appear on the display device when a call is received, wherein said control and regulation unit is configured to identify the calling telecommunication subscriber from the transmitted telephone number or from other caller data which is suitable for identification.

7. The vehicle information system of claim 1, further comprising an interface on the control and regulation unit configured for wire-based or wireless data interchange with other communication apparatuses.

8. The vehicle information system of claim 1, wherein at least some of the image files are linked to audio files.

9. A method for operating the vehicle information system of claim 1, comprising:
using a menu guide to determine a mode of operation for vehicle navigation or a mode of operation for telecommunication;
producing data records by inputting data using the input apparatus and storing the data records in the data store;
linking an image file which has been selected from a plurality of provided, produced, or modified, freely selectable image files displayed on a display device in the vehicle information system to one of the data records by the input apparatus in a learning mode;
storing the link to the respective data record;
displaying linked image files for selecting one of data records from a plurality of data records;
selecting a data record in an image-assisted manner when the input apparatus is operated using the displayed linked image files and stipulating a control command for the selected data record is initiated.
